(19) United States
(12) Patent Application Publication
(10) Pub. No.: US 2026/0313463 A1
(43) Pub. Date: Oct. 8, 2026

(54) SYSTEM TO PLACE AND PROTECT INTERRUPTIBLE WORKLOADS IN CLOUD ENVIRONMENT

(71) Applicant: Microsoft Technology Licensing, LLC, Redmond, WA (US)

(72) Inventors: Yuwen YANG, Kirkland, WA (US); Abhisek PAN, Bellevue, WA (US); Bo QIAO, Beijing (CN); Guanlin BIAN, Beijing (CN); Hang DONG, Beijing (CN); Shijing TU, Beijing (CN); Si QIN, Beijing (CN); Karthikeyan SUBRAMANIAN, Redmond, WA (US); Thomas MOSCIBRODA, Bellevue, WA (US); Ayesha Narayan GURNANI, Bellevue, WA (US); Deepak Niranjan KATARIYA, Seattle, WA (US); Rahul SHARMA, Sammamish, WA (US)

(21) Appl. No.: 19/480,324

(22) PCT Filed: Jun. 1, 2023
(86) PCT No.: PCT/CN2023/097771

§ 371 Date: Oct. 30, 2025

(51) Int. Cl. H04W 28/16; G06F 9/455

(52) U.S. Cl. CPC H04W 28/16; G06F 9/45558

(57) ABSTRACT

The present application relates to a network, apparatus, and method for resource allocation in a distributed wide area network including a plurality of computing resources configured to instantiate virtual machines. A workload manager for the network predicts, using one or more machine-learning algorithms, based on network utilization and eviction information, a set of stable interruptible virtual machine (IVM) resources having an IVM capacity. The network manager receives a plurality of requests for interruptible workloads. The network manager allocates the interruptible workloads to the stable IVM resources up to the IVM capacity. The network manager may predict a rate of requests for priority uninterruptible workloads and a capacity during a future time period, determine to protect at least one of the interruptible workloads based on the rate of requests and the capacity, and guarantee resources to the at least one interruptible workload as a protected workload for the future time period.

### BACKGROUND

A cloud network may be implemented on a wide area network (WAN) that includes computing resources spread across a geographic region and connected via communication links such as fiber optic cables or satellite connectivity. A cloud provider may host cloud applications for its clients. For example, a cloud provider may provide infrastructure as a service (IaaS) services such as virtual machines (VM), platform as a service (PaaS) services such as databases and serverless computing, and software as a service (SaaS) services such as authentication platforms. The size of wide area networks may vary greatly from a small city to a global network. For example, a WAN may connect multiple offices of an enterprise, the customers of a regional telecommunications operator, or a global enterprise. The computing resources and connections within a WAN may be owned and controlled by the WAN operator.

Cloud computing has emerged as a top choice for executing big data analytic workloads in various business domains. To cope with rapidly-increasing demand, cloud vendors have funneled sizable resources into their own managed programming job services. For instance, a programming job service may execute on a coordinated cluster of VMs. Cloud vendors may provide programming job services as IaaS, providing resources for executing a workload. The flexibility of such cloud offerings allows users to easily lease and release compute resources and, consequently, enjoy potentially significant cost effectiveness. However, to provide such flexibility, service providers must address various challenges with respect to resource provisioning.

Programming job services are often offered with a service level agreement that guarantees resources for the programming job such that a customer may plan on completion of the workload. The demand for programming job services, however, may vary over time. Accordingly, a cloud vendor that provisions resources to satisfy peak demand may have unutilized resources when the demand is lower. One use of such unutilized resources is an interruptible workload service that can process a workload when demand for guaranteed services is low. An interruptible workload may be executed on the otherwise unused resources but may be evicted when the resources are demanded by a higher priority workload. Such interruptible workloads, however, raise their own issues with scheduling and customer service. Accordingly, there is a need for management of interruptible workloads within a cloud network.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In some aspects, the techniques described herein relate to an apparatus for resource allocation in a distributed wide area network, including: a memory storing computer-executable instructions; and at least one processor configured to execute the computer-executable instructions to: predict, using one or more machine-learning algorithms, based on network utilization and eviction information, a set of stable interruptible virtual machine (IVM) resources having an IVM capacity; receive plurality of requests for interruptible workloads; and allocate the interruptible workloads to the stable IVM resources up to the IVM capacity.

In some aspects, the techniques described herein relate to an apparatus for resource allocation in a distributed wide area network, including: a memory storing computer-executable instructions; and at least one processor configured to execute the computer-executable instructions to: predict, using one or more machine-learning algorithms, a rate of requests for priority uninterruptible workloads and a capacity for the priority uninterruptible workloads during a future time period; receive a plurality of requests for interruptible workloads; determine to protect at least one of the interruptible workloads during the future time period based on the rate of requests and the capacity; and guarantee resources to the at least one interruptible workload as a protected workload for the future time period.

In some aspects, the techniques described herein relate to a method of resource allocation in a distributed wide area network, including: predicting, using one or more machine-learning algorithms, based on network utilization and eviction information, a set of stable interruptible virtual machine (IVM) resources having an IVM capacity; receiving a plurality of requests for interruptible workloads; and allocating the interruptible workloads to the stable IVM resources up to the IVM capacity.

In some aspects, the techniques described herein relate to a method of resource allocation in a distributed wide area network, including: predicting, using one or more machine-learning algorithms, a rate of requests for priority uninterruptible workloads and a capacity for the priority uninterruptible workloads during a future time period; receiving a plurality of requests for interruptible workloads; determining to protect at least one of the interruptible workloads during the future time period based on the rate of requests and the capacity; and guaranteeing resources to the at least one interruptible workload as a protected workload for the future time period.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram of an example of an architecture for provisioning resources for request to execute workloads in a cloud network, in accordance with aspects described herein.

FIG. 2 is a diagram illustrating behavior of high priority uninterruptible virtual machines (UVMs) and interruptible virtual machines (IVMs) on cloud resources, in accordance with aspects described herein.

FIG. 3 is a diagram of an example structure of a workload manager for placement of IVMs, in accordance with aspects described herein.

FIG. 4 is a diagram of an example structure of the workload manager for protection of IVMs, in accordance with aspects described herein.

FIG. 5 is a resource diagram of example capacities for virtual machines in a cloud network and allocation of resources to requested IVMs, in accordance with aspects described herein.

FIG. 6 is a schematic diagram of an example of an apparatus for placing and protecting interruptible workloads in a cloud network, in accordance with aspects described herein.

FIG. 7 is a flow diagram of an example of a method for placing IVMs on stable IVM resources to reduce evictions, in accordance with aspects described herein.

FIG. 8 is a flow diagram of an example of a method for protecting IVMs from eviction in a cloud network, in accordance with aspects described herein.

FIG. 9 is a schematic diagram of an example of a device for placing and protecting IVMs in a cloud network, in accordance with aspects described herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known components are shown in block diagram form in order to avoid obscuring such concepts.

This disclosure describes various examples related to resource provisioning in large-scale cloud services. The cloud services may provide virtual machines (VMs) for executing workloads. The VMs execute on hardware computing resources such as processing cores and memory that may be on server racks in datacenters. The VMs may be organized into clusters and/or regions.

Conventionally, cloud services face a technical problem of efficiently allocating resources to workloads. For example, due to varying demand for executing workloads, the cloud network is typically provisioned to meet peak demand, but provisioned resources remain idle when demand is low. This problem becomes more complicated as resources are allocated within regions in order to improve communication latency because demand within a region may fluctuate according to a periodic cycle.

One option for using idle resources is to offer a lower priority service that can execute a workload on available resources but may be evicted if a higher priority service requests the resources. Such a service may be referred to as an interruptible virtual machine (IVM) or a spot virtual machine. For instance, IVMs may be suitable for tasks such as development, testing, quality assurance, advanced analytics, big data processing, machine learning and AI, batch jobs, rendering and transcoding of videos, graphics, and images. These tasks may utilize significant resources, but may not have hard timing requirements.

While IVMs can improve efficiency by increasing utilization of resources, the eviction of an IVM may be considered an inefficiency. For example, an eviction may be associated with switching costs or the possibility of wasted processing time. Further, unpredictable evictions may provide a poor experience to evicted users, who may have an expectation of a workload finishing even if resources are not guaranteed.

The present disclosure provides methods and systems for managing IVMs in a cloud network to reduce evictions of interruptible workloads based on predictions of capacity for IVMs and/or higher priority VMs. In one aspect, the system identifies stable resources that are unlikely to experience an eviction and places IVMs on only the stable resources. Resource that frequently experience demand for higher priority VMs that could interrupt the IVMs may be reserved for the higher priority VMs and excluded from hosting IVMs. In a second aspect, the capacity and expected demand for higher priority VMs may be used to establish protected workloads for a period of time. The protected workloads may be uninterruptible for the period of time, but become interruptible after the period of time expires if the protection is not renewed.

In an aspect, the present disclosure provides an apparatus, a wide-area network (WAN), and a method of resource allocation in a distributed wide area network. One or more machine-learning algorithms predict a set of stable interruptible virtual machine (IVM) resource based on network utilization and eviction information. The set of stable IVM resources have an IVM capacity. The system receives a plurality of requests for interruptible workloads and allocates the interruptible workloads to the stable IVM resources up to the IVM capacity. In some implementations, the system may determine whether to protect one of the interruptible workloads based on a rate of requests for priority uninterruptible workloads and a capacity for the priority uninterruptible workloads during a future time period. The system may guarantee resources to the one interruptible workload as a protected workload for the future time period.

The disclosed methods and system may be implemented to achieve one or more of the following technical effects. Allocation of interruptible workloads to a set of resources predicted to be stable in terms of priority workloads may produce a lower eviction rate of the interruptible workloads. The lower eviction rate translates to more efficient usage of network resources. Protection of interruptible workloads for a limited time subject to reserved capacity for priority workloads may result in minimal eviction of interruptible workloads during the limited time. The performance of the protected workloads is improved by reducing expected time to completion. Continuous training of algorithms for predicting capacity and updates to predicted capacity allow predictions to dynamically adapt to demand on the network to improve accuracy of predicted stable resources.

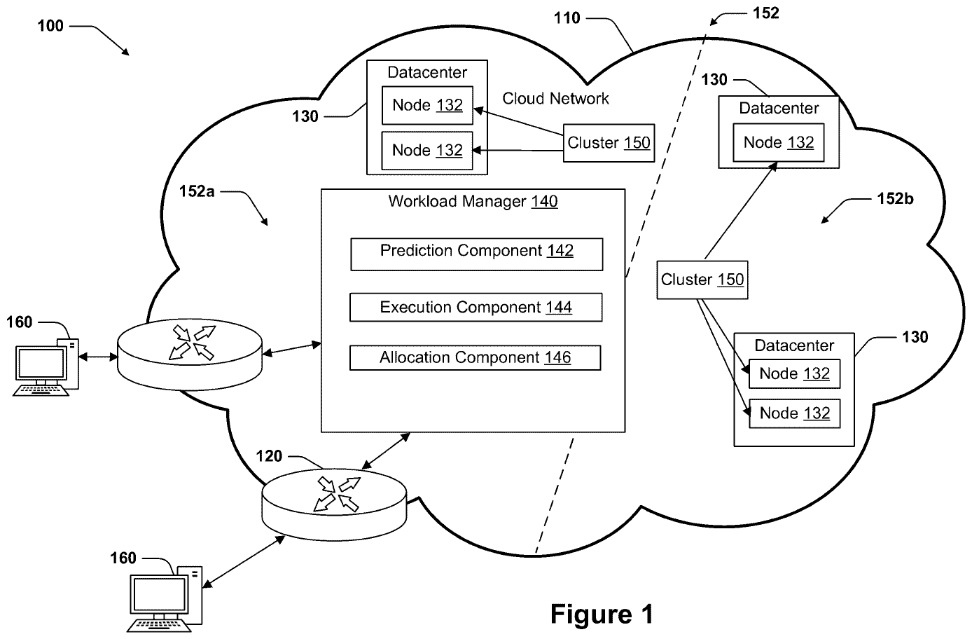

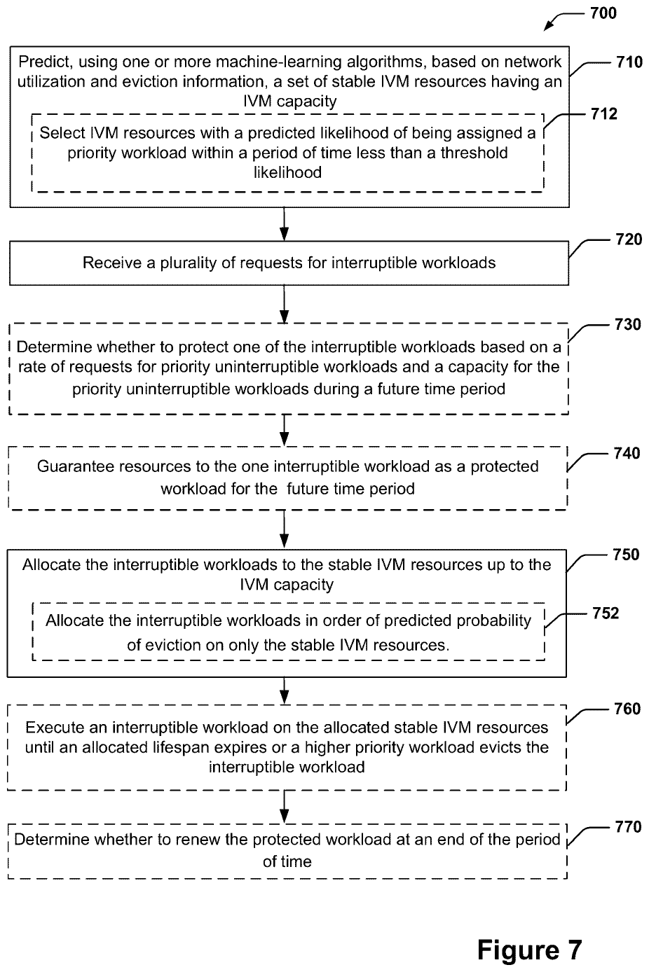

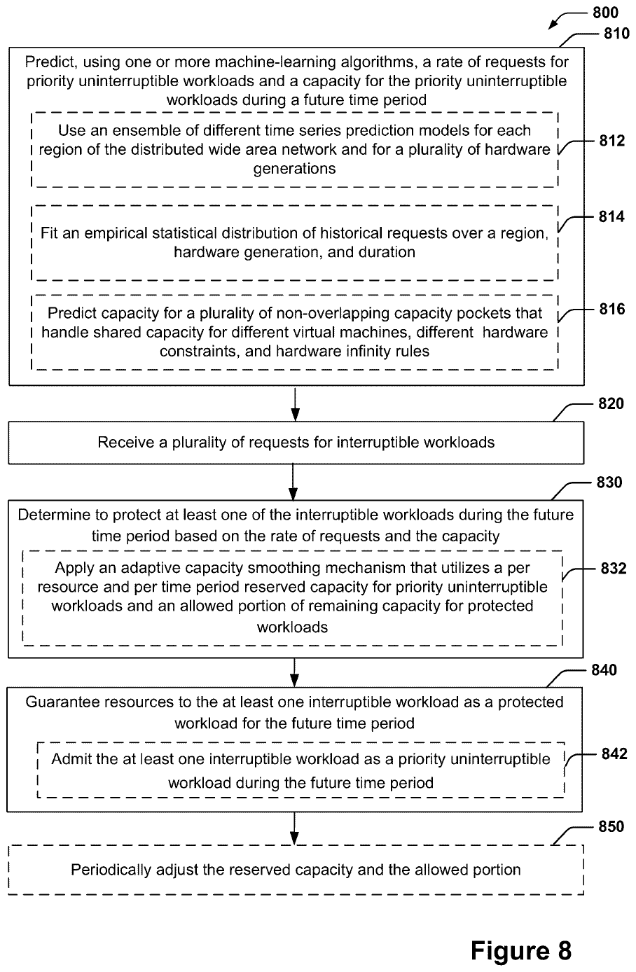

Turning now to FIGS. 1-9, examples are depicted with reference to one or more components and one or more methods that may perform the actions or operations described herein, where components and/or actions/operations in dashed line may be optional. Although the operations described below in FIGS. 7 and 8 are presented in a particular order and/or as being performed by an example component, the ordering of the actions and the components performing the actions may be varied, in some examples, depending on the implementation. Moreover, in some examples, one or more of the actions, functions, and/or described components may be performed by a specially-programmed processor, a processor executing specially-programmed software or computer-readable media, or by any other combination of a hardware component and/or a software component capable of performing the described actions or functions.

FIG. 1 is a conceptual diagram 100 of an example of an architecture for a cloud network 110. The cloud network 110 may include computing resources that are controlled by a network operator and accessible to public clients 160. For example, the cloud network 110 may include a plurality of datacenters 130 that include computing resources such as computer memory and processors. In some implementations, the datacenters 130 may host a compute service that provides computing nodes 132 on computing resources located in the datacenter. The computing nodes 132 may be containerized execution environments with allocated computing resources. For example, the computing nodes 132 may be virtual machines (VMs), process-isolated containers, or kernel-isolated containers. The nodes 132 may be instantiated at a datacenter 130 and imaged with software (e.g., operating system and applications for a service). The cloud network 110 may include edge routers 120 that connect the datacenters 130 to external networks such as internet service providers (ISPs) or other autonomous systems (ASes) that form the Internet.

The cloud network 110 may provide a workload manager 140 that provides nodes for various services. For example, the workload manager 140 may select and allocate resources at various datacenters 130 to instantiate nodes 132 for performing workloads requested by clients 160. The nodes 132 may be arranged into clusters 150. The workload manager 140 may allocate the nodes to a particular workload. Each node may be implemented as a VM. In some implementations, a workload may be executed over a cluster. For example, the workload manager 140 may allocate a plurality of nodes for a workload as a cluster 150. In some implementations, the cloud network 110 may be divided into regions. For example, as illustrated a west region 152a and an east region 152b may each include separate datacenters 130, and the nodes 132 and clusters 150 may be associated with a respective region. A global network may have regions based on continent, country, time zone, or other geographic designation.

The workload manager 140 includes a prediction component 142 configured to predict, using one or more machine-learning algorithms, based on network utilization and eviction information, a set of stable IVM resources having an IVM capacity. Additionally or alternatively, the prediction component 142 is configured to predict, using one or more machine-learning algorithms, a rate of requests for priority uninterruptible workloads and a capacity for the priority uninterruptible workloads during a future time period. The workload manager 140 includes an execution component 144 configured to receive a plurality of requests for interruptible workloads. For instance, the execution component 144 may present a user interface that allows clients 160 to request interruptible and/or priority uninterruptible workloads. The execution component 144 may also handle instantiation of VMs, accounting, policy, and/or eviction. The workload manager 140 includes an allocation component 146 configured to allocate the interruptible workloads to the stable IVM resources up to the IVM capacity. Additionally or alternatively, the allocation component 146 is configured to determine to protect at least one of the interruptible workloads during the future time period based on the rate of requests and the capacity and guarantee resources to the at least one interruptible workload as a protected workload for the future time period.

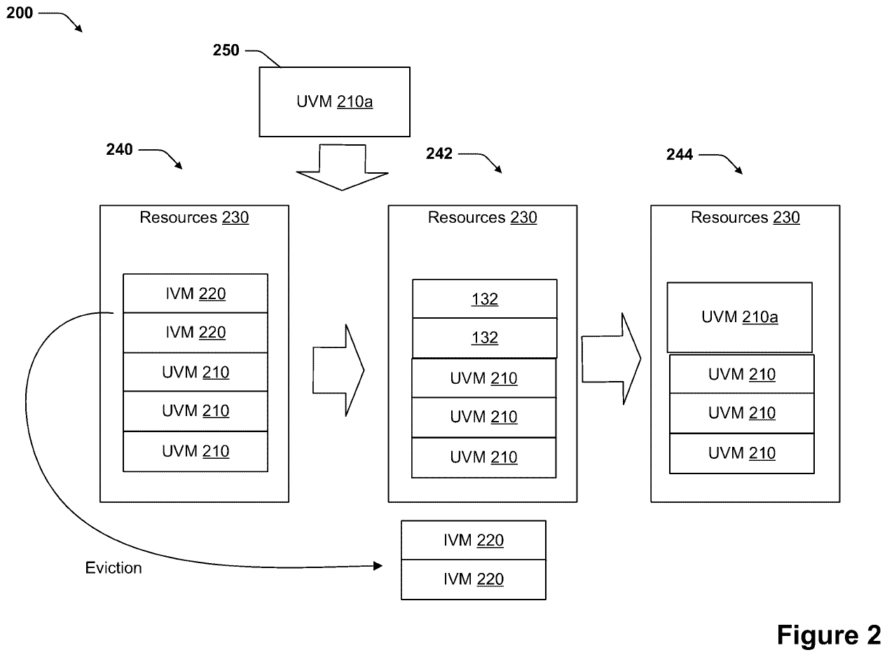

FIG. 2 is a diagram 200 illustrating behavior of high priority uninterruptible VMs (UVMs) 210 and IVMs 220. The UVMs 210 may have absolute priority over the IVMs 220. Once UVM 210 is allocated resources 230, the UVM 210 may continue to use the resources until released by the client 160 or a lease time expires. The IVMs 220 may be allocated to resources that are not being used by a UVM 210. The IVMs 220, however, are not guaranteed the resources 230 and may be evicted when request for a UVM 210 is received.

In the illustrated example, a set of resources 230 may include five nodes 132. In a first stage 240, three of the nodes 132 may be initially allocated to long running UVMs 210. The remaining two nodes 132 may initially be allocated to IVMs 220. During the first stage 240, a request 250 for a new UVM 210a is received. Because the resources 230 are all allocated, the IVMs 220 may be evicted to free resources 230 for the new UVM 210a. In a second stage 242, the three UVMs 210 continue to occupy three of the nodes 132, but two of the nodes are now unoccupied. The IVMs 220 have been evicted. A lifetime of the IVMs 220 may be measured from a time when the IVMs 220 were initiated in the first stage 240 until the eviction in the second stage 242. In a third stage 244, the new UVM 210a may be allocated the unoccupied nodes 132 (e.g., as a cluster 150).

The ability to execute IVMs provides scalability on a broad range of VMs and helps to clients 160 who have workloads that can be interrupted in return for a deeply discounted price. However, certain levels of interruptions for IVMs 220 are observed throughout different regions 152. Particularly, when an IVM 220 is interrupted/evicted within a short amount of time (e.g., 1 hour from creation time), the event may be called “Early Eviction.” Early Eviction has led to an undesired customer experience even when high-priority utilization is relatively low at valley hours. For example, a client 160 attempting to execute an IVM 220 over night while demand is low may be surprised to learn that the IVM 220 was evicted because a UVM 210 needed the particular resources to which the IVM 220 was allocated.

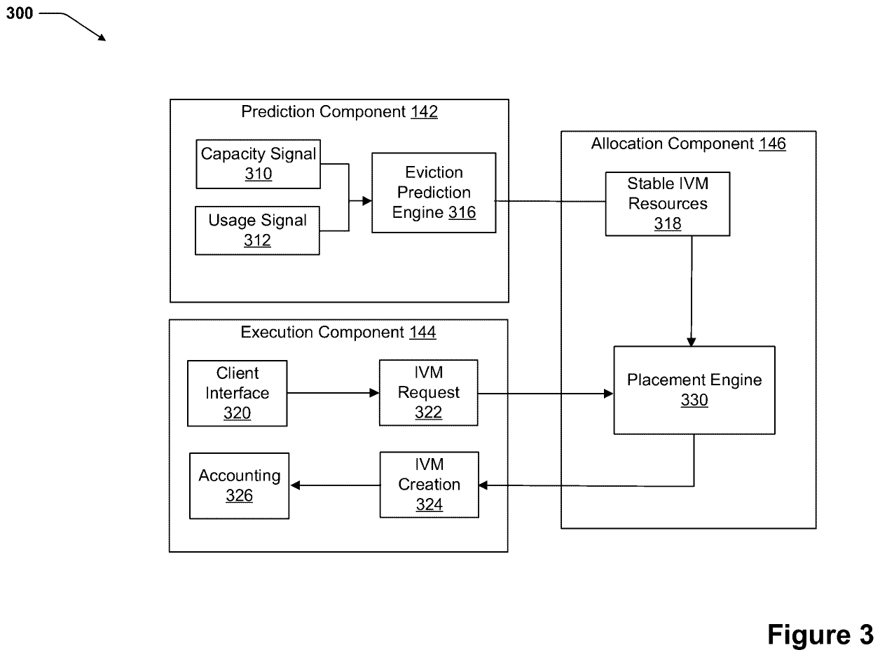

FIG. 3 is a diagram 300 of an example structure of the workload manager 140 for placement of IVMs. As discussed with respect to FIG. 1, the workload manager 140 includes the prediction component 142, the execution component 144, and the allocation component 146.

The prediction component 142 is configured to provide a fully automated and real time stream as a stable IVM capacity prediction signal. The prediction component 142 receives a capacity signal 310 that provides the real time capacity situation in multiple dimensions (e.g., time, node, cluster, region), as well as a usage signal 312 that provides information on the existing workloads of the IVMs 220 and UVMs 210. The capacity signal 310 and the usage signal 312 are fed into a prediction engine 316. Based on the real time stream of the capacity signal 310 and the usage signal 312 as well as the historical data stored, the prediction engine 316 automatically creates a prediction of stable IVM capacities. The prediction includes how many resources (e.g., nodes 132) are available and where the available nodes are located (e.g., which region 152). The prediction is based on how likely the spare capacity in each capacity segment will be occupied by high priority VMs within a future time period (e.g., 1 hour) and is powered at backend by multiple machine-learning-based mechanisms to dive deep into various node level, cluster level, and region level features that are correlated with early evictions (e.g., hardware/software configuration, generation, manufacturer, or existing workloads).

In an implementation, for a capacity segment i, Yᵢ(t) denotes whether a capacity segment i is stable IVM capacity at time t. A machine learning model outputs Yᵢ(t) with a number of features Xᵢ(t). The model Yᵢ(t)~Xᵢ(t) is learned by considering the tradeoff of reducing early eviction rate of IVMs and enlarging the available capacity for allocating more IVMs. Therefore, the loss function for training the

$$L = {Σ}_{i = 1}^{N} 𝕀 ( {P}_{i} ( t ) > γ ) + β \times {Σ}_{i = 1}^{N} {C}_{i} ( t ) ,$$

where Pᵢ(t) is the probability that capacity segment i will have early evicted IVMs at time t, Cᵢ(t) is the available capacity for IVMs for capacity segment i at time t after considering the admission result of Yᵢ(t) (which means Cᵢ(t)=0 if Yᵢ(t)=0, and Cᵢ(t) equals to the actual remaining available capacity for IVMs if Yᵢ(t)=1). γ and β are a threshold parameter and a weight parameter respectively, and [symbol] (⋅) is an indicator function. The final output of the prediction component 142 is provided to the allocation component 146.

The allocation component 146 consumes the prediction signal of the prediction component 142, as well as real time IVM requests from the execution component 144. The allocation component 146 includes a placement engine 330 configured to select resources for placing a requested IVM. Instead of allowing IVMs on all segments of capacity, the placement engine 330 selects an IVM allocation on stable IVM capacities only. In some implementations, the placement engine 330 aims at minimizing the probability that the same segment of capacities will be occupied by high priority VMs soon, thus reducing the early eviction rate. The selected resource allocation is then sent to the execution component 144 for IVM creation on the specific resources to which the IVM is allocated.

The execution component 144 contains other components of the system and performs compute resource lifecycle transition actions. The execution component 144 includes a client interface 320 configured to interact with a client 160. For example, the client interface 320 may display information regarding IVM pricing and conditions. The client interface 320 may receive a request from the client 160 and generate an IVM request 322 with properties of the requested IVM such as requested resources and lifespan. The execution component 144 includes an IVM creation component 324 that is configured to create IVMs 220 on allocated resources 230. The IVM creation component 324 may also evict IVMs 220 if resources are needed for a UVM 210. The execution component 144 includes an accounting component 326 that tracks IVM lifespan and bills clients 160. This architecture splits the responsibilities of making IVM decisions and creating or modifying the underlying workloads. IVM allocation decisions from the allocation component 146 are fulfilled when the requested workload is placed on the allocated resources. The execution component 144 also takes care of the eviction of IVMs in case the capacity is finally occupied by high priority VMs, as well as the IVM deletion when it has reached its lifespan. The creation and deletion information are then sent to the accounting component 326.

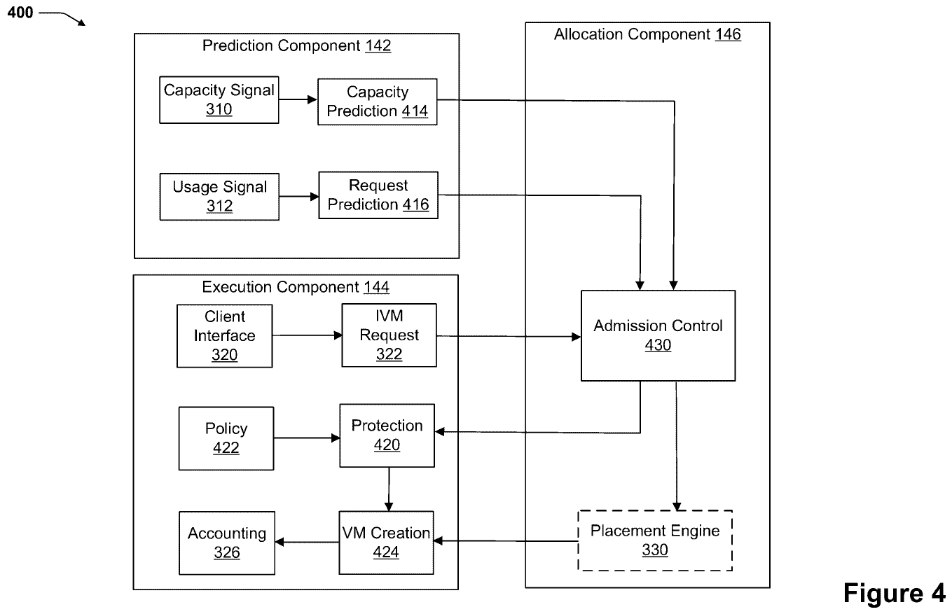

FIG. 4 is a diagram 400 of an example structure of the workload manager 140 for protection of IVMs. As discussed with respect to FIGS. 1 and 3, the workload manager 140 includes the prediction component 142, the execution component 144, and the allocation component 146.

For protection of IVMs, the prediction component 142 is configured to predict capacity and usage of UVMs 210. The predication component 142 includes a capacity prediction engine 414 that predicts capacity based on the capacity signal 310 and a request prediction engine 416 that predicts future IVM requests and demand based on the usage signal 312.

The request prediction engine 416 provides prediction for the future IVM requests and demand. The prediction made is at a non-overlapping granularity of resources that also considers hardware constraints and affinity rules. For example, the resources may be divided into a plurality of resource pockets, and requests may be allocated to a resource pocket based on the hardware constraints and affinity rules. The usage signal 312 is obtained based on all the past requests. The details of the information in each request are extracted and a joint distribution of the request type as well as the duration of the job is also generated by the request prediction engine 416. The distribution is updated periodically as new requests are added to the knowledge base. The request prediction generated by the request prediction engine 416 is then consumed by the admission control component 430 to make real time decisions.

The capacity prediction engine 414 generates a core utilization prediction using historical usage data, and then converts predicted core utilization to projected spare cores by considering buffer management and historical upper bound utilization to account for fragmentation and other platform constraints. To better formulate the actual allocation behavior, the capacity prediction engine 414 utilizes hardware affinity rules for resources of the cloud network 110. The resources of the cloud network 110 can be divided into non-overlapping capacity pockets. For instance, the resources of the cloud network 110 may include multiple types of processing cores from different manufactures. The non-overlapping capacity pockets may group cores with similar capacities for implementing a series of VM. For example, all general purpose cores from a manufacturer within several generations may be able to implement the same series of VM and may be considered a capacity pocket.

The allocation component 146 includes an admission control component 430 configured to determine whether to protect a requested IVM. The allocation component 146 optionally includes the placement engine 330 for placing IVMs on stable IVM resources. The admission control component 430 consumes the predictions from the request prediction engine 416 and the capacity prediction engine 414 output from the prediction component 142. The admission control component 430 is configured to implement a protected IVM (PIVM) admission control mechanism that aims at maximizing a total reward function and minimizing a total penalty function based on whether IVM requests get protected and how such requests are protected.

The admission control component 430 leverages the capacity prediction and request prediction signals from the prediction component 142, as well as the actual IVM requests from the execution component 144. The admission control component 430 determines how many IVM requests can be deployed as high-priority PIVMs and are expected to run without eviction. The admission control component 430 also ensures that PIVM only uses spare capacity without interrupting future high priority workloads. The admission control component 430 also ensures that PIVM does not increase peak utilization and thus does not incur additional platform running costs. To address this need, an Adaptive Capacity Smoothing (ACS) mechanism is used to add an additional safe buffer. Particularly, the admission control component 430 is configured with parameters αᵢₜ and βᵢₜ for a particular capacity pocket i at time t. The αᵢₜ defines a portion of the resources that are allowed to be allocated to a PIVM. The ACS mechanism reserves βᵢₜ capacity as a safe buffer/reservoir and never uses the reserved capacity for PIVM. This ensures that PIVM may never increase peak utilization with future unpredictable VMs that are higher than the prediction. In addition, instead of allowing all the estimated capacity for PIVM at any single time, the admission control component 430 only distributes the αᵢₜ part intelligently over off-peak hours. This helps to distribute workload smoothly over time, and avoids allocating all the possible PIVM in any single hour thus hurting the experience for customer at later time. The parameters αᵢₜ and βᵢₜ are adjusted periodically by learning historical usage data and allocation patterns to improve customer experience and platform efficiency.

The admission control component 430 obtains an actual IVM request 322 from the execution component 144, and then processes the pending IVM requests in real time. The final admission control decisions decide how many IVM requests are to be deployed as PIVMs based on predicted capacity signals, while not increasing peak utilization for total high-priority VMs. The decision is then sent to the execution component 144 to request resource creation or modification

The execution component 144 includes other components of the system and performs the compute resource lifecycle transition actions. As discussed with respect to FIG. 3, the execution component 144 includes the accounting component 326 and the client interface 320 for generating the IVM request 322. The execution component 144 also includes a protection component 420 that is configured to request a PIVM when the admission control component 430 decides to grant a PIVM. The VM creation component 424 is similar to the IVM component 324 and can create IVMs for satisfying an IVM request (for example, based on stable IVM resources indicated by placement engine 330). The VM creation component 424 can also create PIVMs to satisfy an IVM request 322. A PIVM may guarantee resources for an interruptible workload for a limited time. In some implementations, a PIVM may be created as a UVM 210 with a limited lifespan.

This architecture splits the responsibilities of making PIVM decisions and creating or modifying the underlying workloads. The execution component 144 may fulfil an IVM request 322 that has been approved by the allocation component 146 as a high-priority PIVM with approved lifespan, while the rejected IVM requests 322 will still be deployed but as low-priority IVMs 220 that are subject to eviction. The execution component 144 may include a policy component 422 that evaluates an existing live PIVM workload, the policy component 422 may rerun periodically to re-evaluate and notice the allocation component 146 for eviction in case of capacity shortage. Otherwise, when a PIVM reaches its planned lifespan without customer termination, the policy component 422 may provide the PIVM to the allocation component 146 as a request to start a new cycle for the remaining lifespan of the PIVM. That is, the policy component 422 may determine whether to renew the protected workload at an end of the period of time.

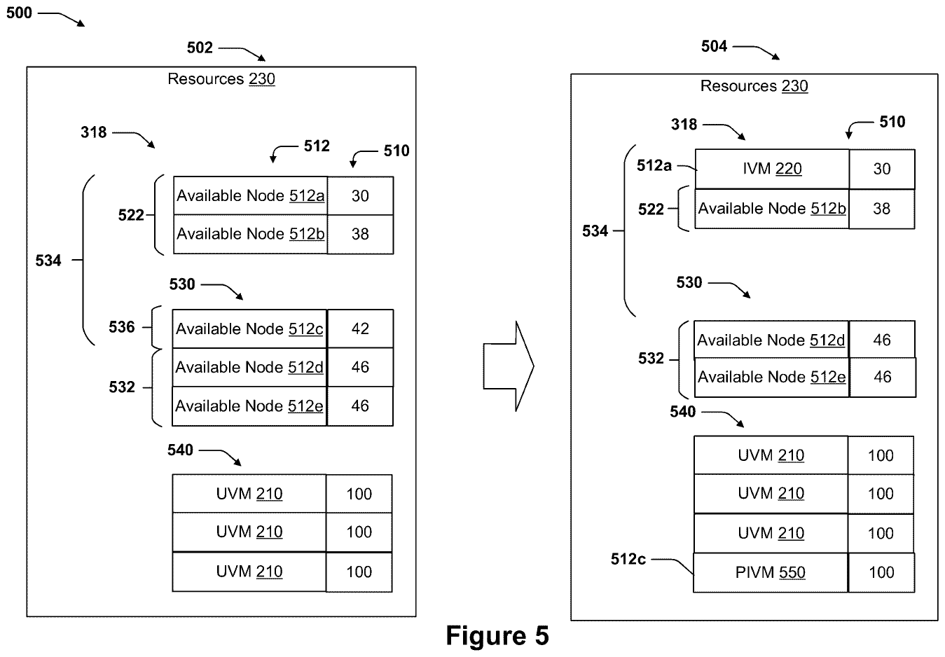

FIG. 5 is a resource diagram 500 of example capacities for IVMs and PIVMs and allocation of resources to requested IVMs. As discussed above, the prediction component 142 may predict utilization and capacity for both IVMs and UVMs. In some implementations, the prediction component 142 may output a likelihood 510 that an available resource is to be allocated to a UVM within a time period.

In an aspect for placement of IVMs, the prediction component 142 may determine a set of stable IVM resources 318 having an IVM capacity 522. For example, the IVM resources 318 may be selected based on the likelihood 510. As illustrated, the IVM resources 318 have less than a 40% chance of being allocated to a UVM within the time period. In some implementations, the resources 230 may be further divided into a set of available resources 530 for UVMs and a set of occupied resources 540.

In an aspect for protection of IVMs, the prediction component 142 may determine a reserved capacity 532 for priority uninterruptible workloads and an allowed portion 536 of remaining capacity 534 for protected workloads. For example, the reserved capacity 532 may only be allocated to workloads requesting a UVM 210. The allowed portion 536 may be used for PIVMs depending on the prediction of remaining capacity 534 for a future time period.

For instance, at a time 502, the resources 230 may include available nodes 512 (e.g., available nodes 512a-512e). Available nodes 512a and 512b may have a low likelihood of being allocated to a UVM and may be considered stable IVM resources. Available nodes 512c, 512d, and 512e may be more likely to be allocated to UVMs. In an aspect, however, it may be unlikely that all of resources 530 are needed for UVMs, so only the reserved capacity 532 is dedicated to workloads requesting UVMs. The remaining capacity 534 including the stable IVM capacity 522 may be allocated for IVMs. In an implementation, the available node 512c may not be considered a stable IVM resource, but may be allocated to satisfy a request for an IVM as a PIVM.

The workload manager 140 may receive two requests for IVMs between time 502 and a time 504. When the allocation component 146 considers the first request 322, the allowed portion 536 may include the available node 512c, so the admission control component 430 may admit the first request 322 as a PIVM 550. In an aspect, the PIVM 550 is implemented as a UVM with a limited lifespan. The node 512c may be considered an occupied resource 540. When the second request 322 is evaluated, there is no allowed portion 536 remaining, so the admission control component 430 only admits the second request 322 as an IVM 220. The placement engine 330 can allocate the IVM 220 to one of the stable IVM resources 318 (e.g., available node 512a). Accordingly at time 504, the reserved capacity 532 (e.g., available nodes 512d and 512e) may remain unchanged from time 502, while the stable IVM capacity may be reduced to available node 512b.

In an implementation, if a request for a UVM is received after time 504, any of nodes 512a, 512b, 512d, or 512e may be allocated to the UVM. If a request for an IVM is received after time 504, only node 512b may be allocated to an IVM. The request for an IVM may not be protected after time 504 as there is no allowed portion 536.

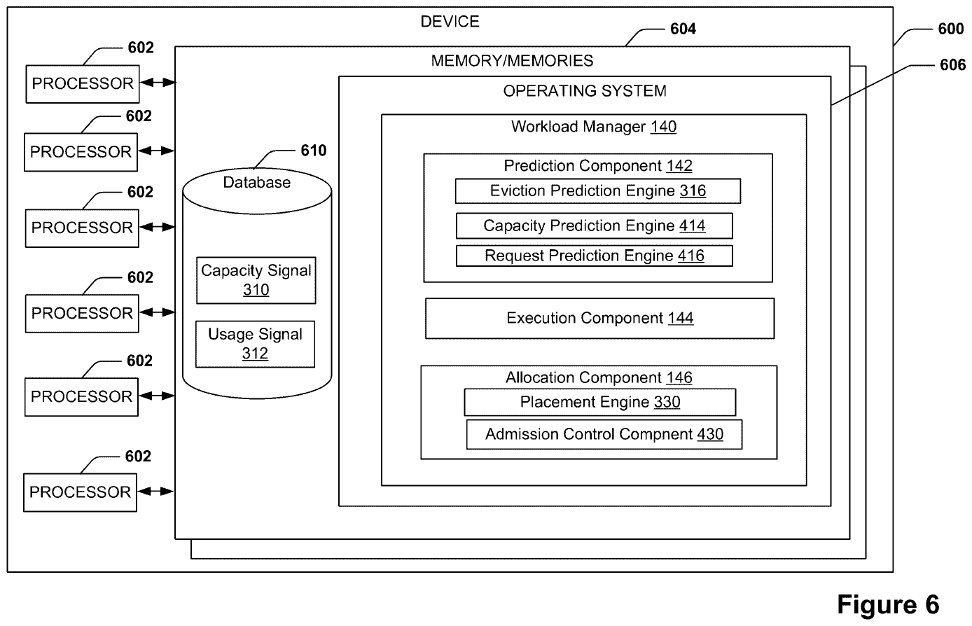

FIG. 6 is a schematic diagram of an example of an apparatus 600 (e.g., a computing device) for placing and protecting interruptible workloads in a cloud network. The apparatus 600 may be implemented as one or more computing devices in the cloud network 110.

In an example, the apparatus 600 includes one or more processors 602 and one or more memories 604 configured to execute or store instructions or other parameters related to providing an operating system 606, which can execute one or more applications or processes, such as, but not limited to, the workload manager 140. For example, processors 602 and memory/memories 604 may be separate components communicatively coupled by a bus (e.g., on a motherboard or other portion of a computing device, on an integrated circuit, such as a system on a chip (SoC), etc.), components integrated within one another (e.g., a processor 602 can include the memory/memories 604 as an on-board component), and/or the like. Memory 604 may store instructions, parameters, data structures, etc. for use/execution by processor 602 to perform functions described herein. In some implementations, the memory/memories 604 include a database 610 for use by the workload manager 140. For example, the database 610 may store measurements and/or metrics for the capacity signal 310 and/or the usage signal 312.

In an example, the workload manager 140 includes the prediction component 142, execution component 144, and allocation component 146. The prediction component 142 may include ML models for predicting likelihood of eviction, future capacity, or future request rate. For example, each of the prediction engine 316, capacity prediction engine capacity prediction engine 414, or request prediction engine 416 may be implemented as an ML model. The execution component 144 may include any of the client interface 320, IVM creation component 324, accounting component 326, protection component 420, policy component 422, or VM creation component 424. The allocation component 146 may include the placement engine 330 and/or the admission control component 430.

In some implementations, the apparatus 600 is implemented as a distributed processing system, for example, with multiple processors 602 and memories 604 distributed across physical systems such as servers, virtual machines, or datacenters 130. For example, one or more of the components of the workload manager 140 may be implemented as services executing at different datacenters 130. The services may communicate via an application programming interface (API).

In an aspect, the prediction component 142 may execute one or more machine-learning algorithms. In some implementations, the prediction component 142 is configured with one or more machine-learning models. The prediction component 142 may update the machine-learning models by performing additional training or adjustment of weights. The following describes example machine-learning algorithms that may be used to predict capacity and/or usage of cloud resources.

There are several metrics used for evaluating the severity of IVM evictions and early evictions. The IVM lifecycle includes of the following: (1) Allocation, (2) Computation, and lastly, (3) Eviction or Termination. The lifetime for the IVM may be defined as the difference in time between creation/allocation and eviction. IVM early evictions are defined as evictions happening in less than 1 hour (equivalently, IVMs with a lifespan of less than 1 hour).

When evaluating the eviction probabilities (or rates) per region, node, or cluster, the creation date of the IVM is of particular importance. For example, a creation window for 2 hours before the time of data retrieval/caching may be used to capture statistics for early eviction. Once the IVMs for a particular creation window are selected, the eviction rate can be calculated as the number of early evicted IVMs divided by the total number of IVMs.

After collecting the node level and container level data for early eviction, multiple ML-based mechanisms are used to identify which node-level features are correlated with early evictions.

Data for training the machine-learning models may be collected from the real-world deployment of a cloud network 110. For example, for each VM or container created on the cloud network 110, an identifier, early eviction status, current eviction status, and lifespan may be tracked over a time interval (e.g., 15 minutes). In addition to container IDs and information, relevant regional, cluster, and node level information can be obtained for each IVM. This allows for training models based on node or cluster level features, while using a container level table. Therefore, the training data may be at the container level, including features of the containers as input and the classification as whether or not the container is evicted. This same model, if trained on node level features, can then be used to predict the probability a given node will result in an early eviction if allocated to an IVM.

Logistic regression may be trained through stochastic gradient ascent, allowing the weights to achieve an optimal target to minimize the error of classification. This results in all the weights being considered simultaneously for the model. In contrast, Naīv̅e Bayes uses the observed counts of each feature and the corresponding class to obtain likelihoods per feature, which are then used to obtain a likelihood assuming all features are independent (i.e., the naīv̅e assumption).

When considering all the features simultaneously in the logistic regression model, the weights can be observed as importance (assuming little covariance and normalization is performed on continuous features). The top-ranking features for both non-eviction and eviction results can be identified based on the weights. Of particular note, the IVM count at the time of creation is correlated with a IVM not being evicted, whereas the presence of high priority VMs is correlated with eviction. Similar features are seen in the likelihoods retrieved from the naīv̅e Bayes model. The difference between the likelihood of eviction from that of non-eviction allowed for obtaining features important to each class independently. A low on-demand VM count is correlated with non-eviction, whereas a high on-demand VM count is correlated with evictions. Similarly, lower node utilization is correlated with non-eviction, whereas high node utilization is correlated with eviction.

Both the logistic regression model and the naīv̅e bayes model have utility in finding features that are important, but there is ambiguity when trying to make sense of each feature independently. Another approach is to use decision tree of depth one per feature, which allows for considering conditions per feature that may be utilized, as well as providing probabilities for eviction and non-eviction.

Based on analysis of a large global-scale cloud network providing IVMs, it was seen that there are several key node level, cluster level, and region level features that are important for IVM eviction and longevity. Node level utilization at the time of IVM creation is an important factor. When the utilization is below ~40% there is nearly an 80% chance that the VM will not be evicted early, whereas the probability of eviction jumps to 62% when above 40% utilization. In addition, having a node level eviction rate above 65% increases the odds of eviction to ~80%. Overall the approach of using depth-limit decision trees per node works as a method to look at feature importance, while also being able to obtain a threshold per feature.

Cluster level features may also be used to predict eviction. Logistic regression and/or a depth−1 decision tree approach may be used to get general feature importance rankings. The region level features that describe the information, properties, and attributes of the overall region such as geographical information, data centers, etc. are useful features. Generally, region types (e.g., Hero, Hub, Satellite) play a role in evictions, but prediction potential may be negligible. General stock keeping units (SKUs) of clusters are not significantly involved in evictions yet decrease the potential an IVM eviction occurs on that cluster. In contrast, GPU SKUs are involved in IVM evictions. If the cluster is a GPU cluster or if it is a specialty compute cluster, then the ranking is leaned toward being correlated with IVM early eviction. Conversely, if the cluster is involved with general compute or contains a high number of health empty nodes ready for a new VM, then the ranking is toward the IVM surviving longer than one hour. Other cluster levels features involved in IVM early eviction outside of SKU types include cluster level eviction rate and cluster and memory utilization. A cluster level eviction rate above ~15-20% increases the odds of a IVM eviction to ~70%. Interestingly, a higher cluster utilization and memory used fraction are correlated with IVMs not being evicted early.

A model may be used to calculate the probability a given node would result in an early eviction. Using this model at a certain time allows for each node to be assigned a probability of eviction and using this model a more accurate number of true IVM capacity may be determined. The model may be a simple logistic regression model. In some implementations, the model may be periodically trained based on recent data. For example, the model may be tested on the previous day and trained on the preceding 3 days. An improvement in the model may be to train it on data from the same day, in which eviction probabilities per node for the current hour are predicted. In practice, classification of the node as stable or unstable is not used since the classification may lead to inaccurate assessments. Instead, the probability of eviction may be ingested directly, allowing for different thresholds to be used. For example, a threshold of 70% may decrease the probability that an IVM is evicted from the node. Conversely, a threshold of 30-40% may be used if the goal is prevent using nodes that may be false negatives for early eviction.

In an aspect, the prediction component 142 (e.g., capacity prediction engine 414) may predict how many IVM requests can be deployed as PIVMs and are expected to run without eviction. Particularly, the prediction component 142 may read a capacity signal 310 such as a core utilization prediction and then convert predicted core utilization to projected spare cores by considering buffer management and historical upper bound utilization to account for fragmentation and other platform constraints. For example, the projected spare cores may be expressed as: ProjectedSpareCoresFractionₜ=max(PeakUtil−PredictedCoresUtilt, 0).

Cores and VMs may not be directly convertible because of potential variation in size of VMs. In an aspect, to address variations in hardware utilization by VMs, resources can be divided into non-overlapping capacity pockets based on hardware affinity rules. For example, capacity pockets may be defined based on manufacturer, specialty (e.g., GPU), and generation of processing resource. The capacity pockets may be associated with a set of supported VM series. Therefore, the total projected spare cores for a future time period (e.g., 1-3 hours) may be estimated for each region and capacity pocket: ProjectedSpareCoresₜ=ProjectedSpareCoresFractionₜ×TotalPhysicalCores.

Using the projected spare cores per time, the prediction component 142 may estimate the maximum projected available PIVM cores from now to the next t hours by as:

$${ProjectedAvailablePIVMCores}_{t} = min ( {ProjectedSpareCores}_{i} , i = 1 , 2 , … , t ) .$$

The prediction component 142 may maintain the list of total cores that can be used for PIVM allocation in the next 3 hours (t=3 in the above equation), and the protection component 420 may ensure the total planned PIVM cores for each capacity pocket never exceeds this value. For VM series that are supported by multiple capacity pockets, earlier generation resources should always be used first before any later generations.

The ACS algorithm and parameters αᵢₜ and βᵢₜ for a particular capacity pocket i at time t provide additional buffer on capacity estimates. The idea and intuition of ACS is that the workload manager 140 reserves βᵢₜ capacity (e.g., reserved capacity 532) as safe buffer/reservoir and never use them for PIVMs. This ensures that PIVMs may never increase peak utilization with future on-demand VMs that is higher than the prediction. In addition, instead of allowing all the estimated cores for PIVMs at any single time, the workload manager 140 only takes αᵢₜ part (e.g., allowed portion 536) and distributes the resources intelligently over off-peak hours. This allows the capacity estimation to update and avoid over counting at any single time.

The new Projected Available Cores while considering βᵢₜ capacity safe buffer may be expressed as:

$${ProjectedSpareCoresFractionWithRes}_{t} = ( 1 - {β}_{it} ) \times max ( PeakUtil - {PredictedCoresUtil}_{t} , 0 )$$

$$And ,$$

$${ProjectedSpareCoresWithRes}_{t} = {ProjectedSpareCoresFractionWithRes}_{t} \times TotalPhysicalCores .$$

Similarly, the maximum VM count that can be converted to PIVMs from a current time to the next t hours after reserving is:

$${ProjectedAvailablePIVMCoresWithRes}_{t} = min ( {ProjectedSpareCoresWithRes}_{i} , i = 1 , 2 , … , t )$$

ProjectedAvailablePIVMCoresWithResₜ is distributed over the above amount over time:

$${AdjustedAvailablePIVMCores}_{t} = {α}_{it} \times ProjectedAvailableSpotV 2 {CoresWithRes}_{t}$$

The above amount (e.g., allowed portion 536) would be the actual number of cores that the workload manager 140 can deploy as PIVMs (e.g., as temporary UVMs). Since this algorithm distributes workload smoothly across time, it also avoids allocating all the possible PIVMs in any single hour thus hurting the experience for customers at a later time.

While βᵢₜ can be retrieved based on projected usage pattern and actual core usage for different VMSize, one simplistic way of determining βᵢₜ is to take a constant, i.e., 10% of the remaining capacity 534. In another word, the workload manager 140 reserves 10% of total capacity as safe buffers. Ideally, βᵢₜ should be different across regions. In some implementations, αᵢₜ may be adjusted over peak and valley hours to further smooth the utilization fluctuation by taking smaller αᵢₜ near peak time and larger values (~100%) right on valley time.

FIG. 7 is a flow diagram of an example of a method 700 for placing IVMs on stable IVM resources to reduce evictions. For example, the method 700 can be performed by the workload manager 140, the apparatus 600 and/or one or more components thereof to execute workloads on clusters of nodes 132 in the cloud network 110.

At block 710, the method 700 includes predicting, using one or more machine-learning algorithms, based on network utilization and eviction information, a set of stable IVM resources having an IVM capacity. In an example, the workload manager 140 and/or predication component 142, e.g., in conjunction with processors 602, memories 604, and operating system 606, can predict, using one or more machine-learning algorithms (e.g., implemented by prediction engine 316), based on network utilization (e.g., usage signal 312) and eviction information (e.g., capacity signal 310), a set of stable IVM resources 318 having an IVM capacity. In some implementations, at sub-block 712, the block 710 may optionally include selecting IVM resources with a predicted likelihood of being assigned a priority workload within a period of time less than a threshold likelihood.

At block 720, the method 700 includes receiving a plurality of requests for interruptible workloads. In an example, the workload manager 140 and/or execution component 142, e.g., in conjunction with processors 602, memories 604, and operating system 606, can receive a plurality of requests for interruptible workloads. For instance, the client interface 320 may receive IVM requests 322 from clients 160.

At block 730, the method 700 may optionally include determining whether to protect one of the interruptible workloads based on a rate of requests for priority uninterruptible workloads and a capacity for the priority uninterruptible workloads during a future time period. In an example, the workload manager 140 and/or admission control component 430, e.g., in conjunction with processors 602, memories 604, and operating system 606, can determine whether to protect one of the interruptible workloads based on a rate of requests for priority uninterruptible workloads and a capacity for the priority uninterruptible workloads during a future time period.

At block 740, the method 700 may optionally include guaranteeing resources to the one interruptible workload as a protected workload for the future time period. The block 740 may be executed in response to determining to protect one of the interruptible workloads in block 730. In an example, the workload manager 140 and/or protection component 420, e.g., in conjunction with processors 602, memories 604, and operating system 606, can guarantee resources to the one interruptible workload as a protected workload for the future time period.

At block 750, the method 700 includes allocating the interruptible workloads to the stable IVM resources up to the IVM capacity. In an example, the workload manager 140 and/or allocation component 146, e.g., in conjunction with processors 602, memories 604, and operating system 606, can allocate the interruptible workloads to the stable IVM resources 318 up to the IVM capacity. In some implementations, at sub-block 752, the block 750 may optionally include allocating the interruptible workloads in order of predicted probability of eviction on only the stable IVM resources 318. For instance, the allocation component 146 may allocate the available resource with the lowest probability of eviction.

At block 760, the method 700 may optionally include executing an interruptible workload on the allocated stable IVM resources until an allocated lifespan expires or a higher priority workload evicts the interruptible workload. In an example, the workload manager 140 and/or IVM creation component 324, e.g., in conjunction with processors 602, memories 604, and operating system 606, can execute an interruptible workload on the allocated stable IVM resources until an allocated lifespan expires or a higher priority workload evicts the interruptible workload.

At block 770, the method 700 may optionally include determining whether to renew the protected workload at an end of the period of time. In an example, the workload manager 140 and/or policy component 422, e.g., in conjunction with processors 602, memories 604, and operating system 606, can determine whether to renew the protected workload at an end of the period of time.

FIG. 8 is a flow diagram of an example of a method 800 for protecting IVMs from eviction in a cloud network. For example, the method 800 can be performed by the workload manager 140, the apparatus 600 and/or one or more components thereof to execute workloads on clusters of nodes 132 in the cloud network 110.

At block 810, the method 800 includes predicting, using one or more machine-learning algorithms, a rate of requests for priority uninterruptible workloads and a capacity for the priority uninterruptible workloads during a future time period. In an example, the workload manager 140 and/or predication component 142, e.g., in conjunction with processors 602, memories 604, and operating system 606, can predict, using one or more machine-learning algorithms, a rate of requests for priority uninterruptible workloads and a capacity for the priority uninterruptible workloads during a future time period. In some implementations, at sub-block 812, the block 810 may optionally include using an ensemble of different time series prediction models for each region of the distributed wide area network and for a plurality of hardware generations. In some implementations, at sub-block 814, the block 810 may optionally include fitting an empirical statistical distribution of historical requests over a region, hardware generation, and duration. In some implementations, at sub-block 816, the block 810 may optionally include predicting capacity for a plurality of non-overlapping capacity pockets that handle shared capacity for different virtual machines, different hardware constraints, and hardware affinity rules.

At block 820, the method 800 includes receiving a plurality of requests for interruptible workloads. In an example, the workload manager 140 and/or execution component 142, e.g., in conjunction with processors 602, memories 604, and operating system 606, can receive a plurality of requests for interruptible workloads. For instance, the client interface 320 may receive IVM requests 322 from clients 160.

At block 830, the method 800 includes determining to protect at least one of the interruptible workloads during the future time period based on the rate of requests and the capacity. In an example, the workload manager 140 and/or admission control component 430, e.g., in conjunction with processors 602, memories 604, and operating system 606, can determine to protect at least one of the interruptible workloads during the future time period based on the rate of requests and the capacity. In some implementations, at sub-block 832, the block 830 may optionally include applying an adaptive capacity smoothing mechanism that utilizes a per resource and per time period reserved capacity for priority uninterruptible workloads and an allowed portion of remaining capacity for protected workloads.

At block 840, the method 800 includes guaranteeing resources to the at least one interruptible workload as a protected workload for the future time period. In an example, the workload manager 140 and/or protection component 420, e.g., in conjunction with processor 602s, memories 604, and operating system 606, can guarantee resources to the at least one interruptible workload as a protected workload for the future time period. In some implementations, at sub-block 842, the block 840 may optionally include admitting the at least one interruptible workload as a priority uninterruptible workload during the future time period.

At block 850, the method 800 may optionally include periodically adjusting the reserved capacity and the allowed portion. In an example, the workload manager 140 and/or allocation component 146, e.g., in conjunction with processors 602, memories 604, and operating system 606, can periodically adjust the reserved capacity and the allowed portion.

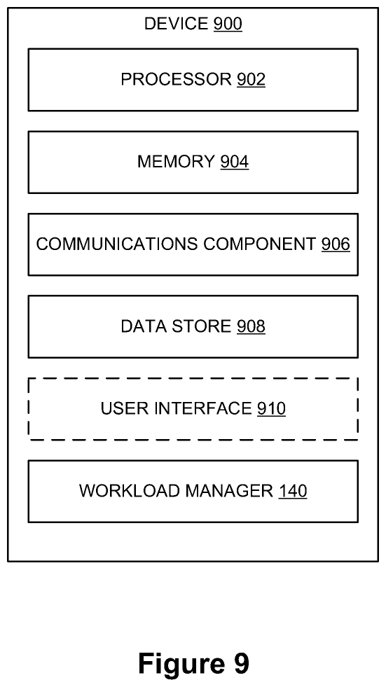

FIG. 9 illustrates an example of a device 900 including additional optional component details as those shown in FIG. 6. In one aspect, device 900 includes processor 902, which may be similar to processor 902 for carrying out processing functions associated with one or more of components and functions described herein. Processor 902 can include a single or multiple set of processors or multi-core processors. Moreover, processor 902 can be implemented as an integrated processing system and/or a distributed processing system.

Device 900 further includes memory 904, which may be similar to memory 904 such as for storing local versions of operating systems (or components thereof) and/or applications being executed by processor 902, such as the workload manager 140, the prediction component 142, the execution component 144, the allocation component 146, etc. Memory 904 can include a type of memory usable by a computer, such as random access memory (RAM), read only memory (ROM), tapes, magnetic discs, optical discs, volatile memory, non-volatile memory, and any combination thereof. The processor 902 may execute instructions stored on the memory 904 to cause the device 900 to perform the methods discussed above with respect to FIGS. 7 and 8.

Further, device 900 includes a communications component 906 that provides for establishing and maintaining communications with one or more other devices, parties, entities, etc. utilizing hardware, software, and services as described herein. Communications component 906 carries communications between components on device 900, as well as between device 900 and external devices, such as devices located across a communications network and/or devices serially or locally connected to device 900. For example, communications component 906 may include one or more buses, and may further include transmit chain components and receive chain components associated with a wireless or wired transmitter and receiver, respectively, operable for interfacing with external devices.

Additionally, device 900 may include a data store 908, which can be any suitable combination of hardware and/or software, that provides for mass storage of information, databases, and programs employed in connection with aspects described herein. For example, data store 908 may be or may include a data repository for operating systems (or components thereof), applications, related parameters, etc. not currently being executed by processor 902. In addition, data store 908 may be a data repository for the workload manager 140.

Device 900 may optionally include a user interface component 910 operable to receive inputs from a user of device 900 and further operable to generate outputs for presentation to the user. User interface component 910 may include one or more input devices, including but not limited to a keyboard, a number pad, a mouse, a touch-sensitive display, a navigation key, a function key, a microphone, a voice recognition component, a gesture recognition component, a depth sensor, a gaze tracking sensor, a switch/button, any other mechanism capable of receiving an input from a user, or any combination thereof. Further, user interface component 910 may include one or more output devices, including but not limited to a display, a speaker, a haptic feedback mechanism, a printer, any other mechanism capable of presenting an output to a user, or any combination thereof.

Device 900 additionally includes the workload manager 140 for predicting, using one or more machine-learning algorithms, based on network utilization and eviction information, a set of stable IVM resources having an IVM capacity; receiving a plurality of requests for interruptible workloads; and allocating the interruptible workloads to the stable IVM resources up to the IVM capacity, etc.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, one or more of the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media. Non-transitory computer-readable media excludes transitory signals.

The following numbered clauses provide an overview of aspects of the present disclosure:

Clause 1. An apparatus for resource allocation in a distributed wide area network, comprising: one or more memories storing computer-executable instructions; and one or more processors, individually or in combination, configured to execute the computer-executable instructions to: predict, using one or more machine-learning algorithms, based on network utilization and eviction information, a set of stable interruptible virtual machine (IVM) resources having an IVM capacity; receive plurality of requests for interruptible workloads; and allocate the interruptible workloads to the stable IVM resources up to the IVM capacity.

Clause 2. The apparatus of clause 1, wherein to predict the set of stable IVM resources the one or more processors, individually or in combination, are configured to select IVM resources with a predicted likelihood of being assigned a priority workload within a period of time less than a threshold likelihood.

Clause 3. The apparatus of clause 1 or 2, wherein one or more of the machine-learning algorithms are trained considering a tradeoff of reducing an early eviction rate of IVMs and enlarging the IVM capacity using a loss function based on a probability of eviction and remaining available IVM capacity.

Clause 4. The apparatus of any of clauses 1-3, wherein the one or more processors, individually or in combination, are configured to periodically perform the predicting to update the set of stable IVM resources based on current network utilization and capacity.

Clause 5. The apparatus of any of clauses 1-4, wherein the one or more machine-learning algorithms include an ensemble of different machine learning and artificial intelligence models at different capacity segments based on node level features, cluster level features, and region level features that are correlated with early evictions.

Clause 6. The apparatus of clause 5, wherein the node level features include hardware constraints, software configuration, generation, manufacturer, and existing workloads.

Clause 7. The apparatus of any of clauses 1-6, wherein to allocate the interruptible workloads to the stable IVM resources up to the IVM capacity, the one or more processors, individually or in combination, are configured to allocate the interruptible workloads in order of predicted probability of eviction on only the stable IVM resources.

Clause 8. The apparatus of any of clauses 1-7, further wherein the one or more processors, individually or in combination, are configured to execute an interruptible workload on the allocated stable IVM resources until an allocated lifespan expires or a higher priority workload evicts the interruptible workload.

Clause 9. The apparatus of any of clauses 1-8, wherein the one or more processors, individually or in combination, are configured to: determine whether to protect one of the interruptible workloads based on a rate of requests for priority uninterruptible workloads and a capacity for the priority uninterruptible workloads during a future time period; and guarantee resources to the one interruptible workload as a protected workload for the future time period.

Clause 10. The apparatus of clause 9, wherein the one or more processors, individually or in combination, are configured to determine whether to renew the protected workload at an end of the period of time.

Clause 11. An apparatus for resource allocation in a distributed wide area network, comprising: one or more memories storing computer-executable instructions; and one or more processors, individually or in combination, configured to execute the computer-executable instructions to: predict, using one or more machine-learning algorithms, a rate of requests for priority uninterruptible workloads and a capacity for the priority uninterruptible workloads during a future time period; receive a plurality of requests for interruptible workloads; determine to protect at least one of the interruptible workloads during the future time period based on the rate of requests and the capacity; and guarantee resources to the at least one interruptible workload as a protected workload for the future time period.

Clause 12. The apparatus of clause 11, wherein to guarantee resources to the at least one interruptible workload as the protected workload for the future time period, the one or more processors, individually or in combination, are configured to admit the at least one interruptible workload as a priority uninterruptible workload during the future time period.

Clause 13. The apparatus of clause 11 or 12, wherein the one or more processors, individually or in combination, are configured to: predict, using the one or more machine-learning algorithms, based on network utilization and eviction information, a set of stable interruptible virtual machine (IVM) resources having an IVM capacity; and allocate at least one of the interruptible workloads that is not protected to the stable IVM resources up to the IVM capacity.

Clause 14. The apparatus of any of clauses 11-13, wherein the one or more processors, individually or in combination, are configured to apply an adaptive capacity smoothing mechanism that utilizes a per resource pocket and per time period reserved capacity for priority uninterruptible workloads and an allowed portion of remaining capacity for protected workloads.

Clause 15. The apparatus of clause 14, wherein one or more processors, individually or in combination, are configured to periodically adjust the reserved capacity and the allowed portion.

Clause 16. The apparatus of any of clauses 11-15, wherein to predict the capacity for the priority uninterruptible workloads during the future time period, the one or more processors, individually or in combination, are configured to use an ensemble of different time series prediction models for each region of the distributed wide area network and for a plurality of hardware generations.

Clause 17. The apparatus of any of clauses 11-16, wherein to predict, using the one or more machine-learning algorithms, the rate of requests for priority uninterruptible workloads one or more processors, individually or in combination, are configured to fit an empirical statistical distribution of historical requests over a region, hardware generation, and duration.

Clause 18. The apparatus of any of clauses 11-17, wherein to predict, using the one or more machine-learning algorithms, the one or more processors, individually or in combination, are configured to predict capacity for a plurality of non-overlapping capacity pockets that handle shared capacity for different virtual machines, different hardware constraints, and hardware affinity rules.

Clause 19. The apparatus of any of clauses 11-18, wherein the one or more processors, individually or in combination, are configured to determine whether to renew the protected workload at an end of the period of time.

Clause 20. A method of resource allocation in a distributed wide area network, comprising: predicting, using one or more machine-learning algorithms, based on network utilization and eviction information, a set of stable interruptible virtual machine (IVM) resources having an IVM capacity; receiving a plurality of requests for interruptible workloads; and allocating the interruptible workloads to the stable IVM resources up to the IVM capacity.

Clause 21. The method of clause 20, wherein predicting the set of stable IVM resources comprises selecting IVM resources with a predicted likelihood of being assigned a priority workload within a period of time less than a threshold likelihood.

Clause 22. The method of clause 20 or 21, wherein one or more of the machine-learning algorithms are trained considering a tradeoff of reducing an early eviction rate of IVMs and enlarging the IVM capacity using a loss function based on a probability of eviction and remaining available IVM capacity.

Clause 23. The method of any of clauses 20-22, wherein the predicting is performed periodically to update the set of stable IVM resources based on current network utilization and capacity.

Clause 24. The method of any of clauses 20-23, wherein the one or more machine-learning algorithms include an ensemble of different machine learning and artificial intelligence models at different capacity segments based on node level features, cluster level features, and region level features that are correlated with early evictions.

Clause 25. The method of clause 24, wherein the node level features include hardware constraints, software configuration, generation, manufacturer, and existing workloads.

Clause 26. The method of any of clauses 20-25, wherein allocating the interruptible workloads to the stable IVM resources up to the IVM capacity comprises allocating the interruptible workloads in order of predicted probability of eviction on only the stable IVM resources.

Clause 27. The method of any of clauses 20-26, further comprising executing an interruptible workload on the allocated stable IVM resources until an allocated lifespan expires or a higher priority workload evicts the interruptible workload.

Clause 28. The method of any of clauses 20-27, further comprising: determining whether to protect one of the interruptible workloads based on a rate of requests for priority uninterruptible workloads and a capacity for the priority uninterruptible workloads during a future time period; and guaranteeing resources to the one interruptible workload as a protected workload for the future time period.

Clause 29. The method of clause 28, further comprising determining whether to renew the protected workload at an end of the period of time.

Clause 30. A method of resource allocation in a distributed wide area network, comprising: predicting, using one or more machine-learning algorithms, a rate of requests for priority uninterruptible workloads and a capacity for the priority uninterruptible workloads during a future time period; receiving a plurality of requests for interruptible workloads; determining to protect at least one of the interruptible workloads during the future time period based on the rate of requests and the capacity; and guaranteeing resources to the at least one interruptible workload as a protected workload for the future time period.

Clause 31. The method of clause 30, wherein guaranteeing resources to the at least one interruptible workload as the protected workload for the future time period comprises admitting the at least one interruptible workload as a priority uninterruptible workload during the future time period.

Clause 32. The method of clause 30 or 31, further comprising: predicting, using the one or more machine-learning algorithms, based on network utilization and eviction information, a set of stable interruptible virtual machine (IVM) resources having an IVM capacity; and allocating at least one of the interruptible workloads that is not protected to the stable IVM resources up to the IVM capacity.

Clause 33. The method of any of clauses 30-32, wherein the method comprises applying an adaptive capacity smoothing mechanism that utilizes a per resource and per time period reserved capacity for priority uninterruptible workloads and an allowed portion of remaining capacity for protected workloads.

Clause 34. The method of clause 33, further comprising periodically adjusting the reserved capacity and the allowed portion.

Clause 35. The method of any of clauses 30-34, wherein predicting, using the one or more machine-learning algorithms, the capacity for the priority uninterruptible workloads during the future time period comprises using an ensemble of different time series prediction models for each region of the distributed wide area network and for a plurality of hardware generations.

Clause 36. The method of any of clauses 30-35, wherein predicting, using the one or more machine-learning algorithms, the rate of requests for priority uninterruptible workloads comprises fitting an empirical statistical distribution of historical requests over a region, hardware generation, and duration.

Clause 37. The method of any of clauses 30-36, wherein predicting, using the one or more machine-learning algorithms, comprises predicting capacity for a plurality of non-overlapping capacity pockets that handle shared capacity for different virtual machines, different hardware constraints, and hardware affinity rules.

Clause 38. The method of any of clauses 30-37, further comprising determining whether to renew the protected workload at an end of the period of time.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described herein that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

1. An apparatus for resource allocation in a distributed wide area network, comprising:
one or more memories storing computer-executable instructions; and
one or more processors, individually or in combination, configured to execute the computer-executable instructions to:
predict, using one or more machine-learning algorithms, based on network utilization and eviction information, a set of stable interruptible virtual machine resources having an IVM capacity;
receive a plurality of requests for interruptible workloads; and
allocate the interruptible workloads to the stable IVM resources up to the IVM capacity.

2. The apparatus of claim 1, wherein to predict the set of stable IVM resources the one or more processors, individually or in combination, are configured to select IVM resources with a predicted likelihood of being assigned a priority workload within a period of time less than a threshold likelihood.

3. The apparatus of claim 1, wherein one or more of the machine-learning algorithms are trained considering a tradeoff of reducing an early eviction rate of IVMs and enlarging the IVM capacity using a loss function based on a probability of eviction and remaining available IVM capacity.

4. The apparatus of claim 1, wherein the one or more processors, individually or in combination, are configured to periodically perform the predicting to update the set of stable IVM resources based on current network utilization and capacity.

5. The apparatus of claim 1, wherein the one or more machine-learning algorithms include an ensemble of different machine learning and artificial intelligence models at different capacity segments based on node level features, cluster level features, and region level features that are correlated with early evictions.

6. The apparatus of claim 5, wherein the node level features include hardware constraints, software configuration, generation, manufacturer, and existing workloads.

7. The apparatus of claim 1, wherein to allocate the interruptible workloads to the stable IVM resources up to the IVM capacity, the one or more processors, individually or in combination, are configured to allocate the interruptible workloads in order of predicted probability of eviction on only the stable IVM resources.

8. The apparatus of claim 1, further wherein the one or more processors, individually or in combination, are configured to execute an interruptible workload on the allocated stable IVM resources until an allocated lifespan expires or a higher priority workload evicts the interruptible workload.

9. The apparatus of claim 1, wherein the one or more processors, individually or in combination, are configured to:
determine whether to protect one of the interruptible workloads based on a rate of requests for priority uninterruptible workloads and a capacity for the priority uninterruptible workloads during a future time period; and
guarantee resources to the one interruptible workload as a protected workload for the future time period.

10. The apparatus of claim 9, wherein the one or more processors, individually or in combination, are configured to determine whether to renew the protected workload at an end of the period of time.

11. An apparatus for resource allocation in a distributed wide area network, comprising:
one or more memories storing computer-executable instructions; and
one or more processors, individually or in combination, configured to execute the computer-executable instructions to:
predict, using one or more machine-learning algorithms, a rate of requests for priority uninterruptible workloads and a capacity for the priority uninterruptible workloads during a future time period;
receive a plurality of requests for interruptible workloads;
determine to protect at least one of the interruptible workloads during the future time period based on the rate of requests and the capacity; and
guarantee resources to the at least one interruptible workload as a protected workload for the future time period.

12. The apparatus of claim 11, wherein to guarantee resources to the at least one interruptible workload as the protected workload for the future time period, the one or more processors, individually or in combination, are configured to admit the at least one interruptible workload as a priority uninterruptible workload during the future time period.

13. The apparatus of claim 11, wherein the one or more processors, individually or in combination, are configured to:
predict, using the one or more machine-learning algorithms, based on network utilization and eviction information, a set of stable interruptible virtual machine (IVM) resources having an IVM capacity; and
allocate at least one of the interruptible workloads that is not protected to the stable IVM resources up to the IVM capacity.

14. The apparatus of claim 11, wherein the one or more processors, individually or in combination, are configured to apply an adaptive capacity smoothing mechanism that utilizes a per resource pocket and per time period reserved capacity for priority uninterruptible workloads and an allowed portion of remaining capacity for protected workloads.

15. The apparatus of claim 14, wherein one or more processors, individually or in combination, are configured to periodically adjust the reserved capacity and the allowed portion.

16. The apparatus of claim 11, wherein to predict the capacity for the priority uninterruptible workloads during the future time period, the one or more processors, individually or in combination, are configured to use an ensemble of different time series prediction models for each region of the distributed wide area network and for a plurality of hardware generations.

17. The apparatus of claim 11, wherein to predict, using the one or more machine-learning algorithms, the rate of requests for priority uninterruptible workloads one or more processors, individually or in combination, are configured to fit an empirical statistical distribution of historical requests over a region, hardware generation, and duration.

18. The apparatus of claim 11, wherein to predict, using the one or more machine-learning algorithms, the one or more processors, individually or in combination, are configured to predict capacity for a plurality of non-overlapping capacity pockets that handle shared capacity for different virtual machines, different hardware constraints, and hardware affinity rules.

19. The apparatus of claim 11, wherein the one or more processors, individually or in combination, are configured to determine whether to renew the protected workload at an end of the period of time.

20. A method of resource allocation in a distributed wide area network, comprising:
predicting, using one or more machine-learning algorithms, based on network utilization and eviction information, a set of stable interruptible virtual machine (IVM) resources having an IVM capacity;
receiving a plurality of requests for interruptible workloads; and
allocating the interruptible workloads to the stable IVM resources up to the IVM capacity.

21. The method of claim 20, wherein predicting the set of stable IVM resources comprises selecting IVM resources with a predicted likelihood of being assigned a priority workload within a period of time less than a threshold likelihood.

22. The method of claim 20, wherein one or more of the machine-learning algorithms are trained considering a tradeoff of reducing an early eviction rate of IVMs and enlarging the IVM capacity using a loss function based on a probability of eviction and remaining available IVM capacity.

23. The method of claim 20, wherein the predicting is performed periodically to update the set of stable IVM resources based on current network utilization and capacity.

24. The method of claim 20, wherein the one or more machine-learning algorithms include an ensemble of different machine learning and artificial intelligence models at different capacity segments based on node level features, cluster level features, and region level features that are correlated with early evictions.

25. The method of claim 24, wherein the node level features include hardware constraints, software configuration, generation, manufacturer, and existing workloads.

26. The method of claim 20, wherein allocating the interruptible workloads to the stable IVM resources up to the IVM capacity comprises allocating the interruptible workloads in order of predicted probability of eviction on only the stable IVM resources.

27. The method of claim 20, further comprising executing an interruptible workload on the allocated stable IVM resources until an allocated lifespan expires or a higher priority workload evicts the interruptible workload.

28. The method of claim 20, further comprising:
determining whether to protect one of the interruptible workloads based on a rate of requests for priority uninterruptible workloads and a capacity for the priority uninterruptible workloads during a future time period; and
guaranteeing resources to the one interruptible workload as a protected workload for the future time period.

29. The method of claim 28, further comprising determining whether to renew the protected workload at an end of the period of time.

30. A method of resource allocation in a distributed wide area network, comprising:
predicting, using one or more machine-learning algorithms, a rate of requests for priority uninterruptible workloads and a capacity for the priority uninterruptible workloads during a future time period;
receiving a plurality of requests for interruptible workloads;
determining to protect at least one of the interruptible workloads during the future time period based on the rate of requests and the capacity; and
guaranteeing resources to the at least one interruptible workload as a protected workload for the future time period.

31. The method of claim 30, wherein guaranteeing resources to the at least one interruptible workload as the protected workload for the future time period comprises admitting the at least one interruptible workload as a priority uninterruptible workload during the future time period.

32. The method of claim 30, further comprising:
predicting, using the one or more machine-learning algorithms, based on network utilization and eviction information, a set of stable interruptible virtual machine (IVM) resources having an IVM capacity; and
allocating at least one of the interruptible workloads that is not protected to the stable IVM resources up to the IVM capacity.

33. The method of claim 30, wherein the method comprises applying an adaptive capacity smoothing mechanism that utilizes a per resource and per time period reserved capacity for priority uninterruptible workloads and an allowed portion of remaining capacity for protected workloads.

34. The method of claim 33, further comprising periodically adjusting the reserved capacity and the allowed portion.

35. The method of claim 30, wherein predicting, using the one or more machine-learning algorithms, the capacity for the priority uninterruptible workloads during the future time period comprises using an ensemble of different time series prediction models for each region of the distributed wide area network and for a plurality of hardware generations.

36. The method of claim 30, wherein predicting, using the one or more machine-learning algorithms, the rate of requests for priority uninterruptible workloads comprises fitting an empirical statistical distribution of historical requests over a region, hardware generation, and duration.

37. The method of claim 30, wherein predicting, using the one or more machine-learning algorithms, comprises predicting capacity for a plurality of non-overlapping capacity pockets that handle shared capacity for different virtual machines, different hardware constraints, and hardware affinity rules.

38. The method of claim 30, further comprising determining whether to renew the protected workload at an end of the period of time.
